(19) United States
(12) Patent Application Publication
(10) Pub. No.: US 2026/0075181 A1
(43) Pub. Date: Mar. 12, 2026

(54) Electronic Devices with Gaze Tracking Circuitry

(71) Applicant: Apple Inc., Cupertino, CA (US)

(72) Inventors: Yu Horie, San Jose, CA (US); Patrick R. Gill, Victoria (CA); Samuel Steven, Cupertino, CA (US)

(21) Appl. No.: 19/209,508

(22) Filed: May 15, 2025

Related U.S. Application Data
(60) Provisional application No. 63/692,555, filed on Sep. 9, 2024.

(51) Int. Cl. H04N 13/383; G02B 27/00; G02B 27/01; H04N 13/128; H04N 13/344

(52) U.S. Cl. CPC H04N 13/383; G02B 27/0093; G02B 27/0172; G02B 27/0179; H04N 13/128; H04N 13/344; G02B 2027/0138; G02B 2027/014; G02B 2027/0178; G02B 2027/0187

(57) ABSTRACT

Eyewear such as a head-mounted device may include adjustable prescription lenses and/or displays. The eyewear may include gaze tracking circuitry that tracks a gaze direction of a user. A depth sensor may measure a depth map of an environment that is viewed through the lens. Using the principals of vergence, a fixation distance may be determined based on the binocular gaze directions of the user. The estimated fixation distance may be cross-checked with the depth map to obtain a more accurate fixation distance estimate. For example, when the gaze tracking circuitry detects a change in gaze direction that exceeds a threshold, a depth map may be analyzed to determine where the new gaze position intersects with the depth map. If desired, depth data may only be gathered and/or analyzed for a subregion of the environment surrounding the measured gaze position.

This application claims the benefit of U.S. provisional patent application No. 63/692,555, filed Sep. 9, 2024, which is hereby incorporated by reference herein in its entirety.

### FIELD

This relates generally to electronic devices, and, more particularly, to wearable electronic devices such as head-mounted devices.

### BACKGROUND

Head-mounted devices and other eyewear may use gaze tracking circuitry to track a user's gaze.

It can be challenging to accurately determine a distance at which a user's gaze is fixated using gaze tracking circuitry. Small amounts of error in measured gaze position can result in significant errors in the estimated fixation distance.

### SUMMARY

Eyewear such as a head-mounted device may include adjustable prescription lenses and/or may include displays. The lenses and displays may be mounted to a support structure such as supporting frames or other head-mounted support structures.

The eyewear may include gaze tracking circuitry that tracks a gaze direction of a user. The gaze tracking circuitry may include light-emitting diodes and a camera. Using the principals of vergence, a fixation distance may be determined based on the gaze direction of the user. The prescription lenses and/or the displays may be adjusted based on the fixation distance. For example, an adjustable lens such as a liquid crystal lens may have an optical power that is adjusted based on the fixation distance at which a user's gaze is fixated.

A depth sensor may measure a depth map of an environment that is viewed through the lens. The vergence-based fixation distance estimate may be cross-checked with the depth map to obtain a more accurate fixation distance estimate. For example, when the gaze tracking circuitry detects a change in gaze direction that exceeds a predetermined threshold, the depth sensor may measure a depth map of the environment and a new fixation distance may be calculated based on where the new gaze position intersects with the depth map. The fixation distance may be determined using a histogram of depth values measured within a subregion surrounding the measured gaze position. If desired, the depth sensor may only be active around the subregion surrounding the gaze position and/or may be steered to illuminate and/or detect light within the subregion surrounding the gaze position.

### BRIEF DESCRIPTION OF THE DRAWINGS

FIG. 1 is a top view of an illustrative head-mounted device that may include gaze tracking circuitry in accordance with some embodiments.

FIG. 2 is a schematic diagram of an illustrative head-mounted device that may include gaze tracking circuitry in accordance with some embodiments.

FIG. 3 is a top view of illustrative gaze tracking circuitry being used to track a gaze direction of a user in accordance with some embodiments.

FIG. 4 is a diagram showing how gaze direction may be used to estimate fixation distance in accordance with some embodiments.

FIG. 5 is a diagram of an illustrative depth map that may be used in combination with gaze information to determine a fixation distance in accordance with some embodiments.

FIG. 6 is a graph showing how estimated fixation distance may change over time during operation of an electronic device in accordance with some embodiments.

FIG. 7 is a diagram of an illustrative depth map that may be used in combination with gaze information to determine a fixation distance in accordance with some embodiments.

FIG. 8 is a histogram of depth sensor values that may be analyzed in connection with gaze information to determine a fixation distance in accordance with some embodiments.

FIG. 9 is a diagram of an illustrative depth map showing how depth data may be gathered from a region of the environment based on information from gaze tracking circuitry in accordance with some embodiments.

### DETAILED DESCRIPTION

Eyewear such as a pair of glasses or other head-mounted device may include one or more eye monitoring components such as gaze tracking circuitry for determining the direction of a user's gaze. Gaze direction may be used to estimate fixation distance. For example, gaze tracking circuitry may track the locations of a user's eyes (e.g., pupils) and may compute gaze vectors for each eye using video-oculography or other suitable gaze tracking techniques. Fixation distance (e.g., the distance at which a user's gaze is fixated) may be computed by finding the intersection of the two binocular gaze vectors from the user's left and right eyes, respectively. This is sometimes referred to as a vergence-based fixation depth estimation.

In some arrangements, gaze tracking sensors may be used in combination with depth sensors to determine fixation distance. For example, a head-mounted device or other eyewear may include one or more depth sensors for gathering depth maps of the environment that the user is viewing through the head-mounted device. The gaze tracking circuitry may determine a direction of the user's gaze, and the depth map from the depth sensor may be analyzed to determine where on the depth map the user's gaze is positioned. The fixation distance may be determined based on the measured depth values at a location on the depth map that intersects with the measured gaze position.

Combining depth sensor data with gaze tracking sensor data to determine fixation distance may produce more accurate results in some situations. Care should be taken however, to account for ambiguities in the depth sensing data. For example, if the user is fixating on a small object, a sharp edge, and/or a transparent object, there may be a greater likelihood for error when estimating the fixation distance. To reduce errors in fixation distance estimations, control circuitry may hold off on calculating a new fixation distance until a rapid change in vergence is detected (e.g., a threshold change in vergence within a threshold amount of time). A change in gaze position that exceeds a predetermined threshold and that occurs within a predetermined time span may trigger the depth sensor to capture a new depth map so that a new fixation distance can be determined based on where the updated gaze position intersects with the new depth map.

In some arrangements, a histogram of measured depth values around the measured gaze position may be analyzed in conjunction with a vergence-based fixation depth estimate to more accurately determine a user's fixation depth. In some arrangements, a depth sensor may only measure depth in a region around the measured gaze position and/or may be steered toward the measured gaze position. These techniques may be implemented individually or in combination with one another to more accurately determine fixation distance using gaze information and depth sensor data.

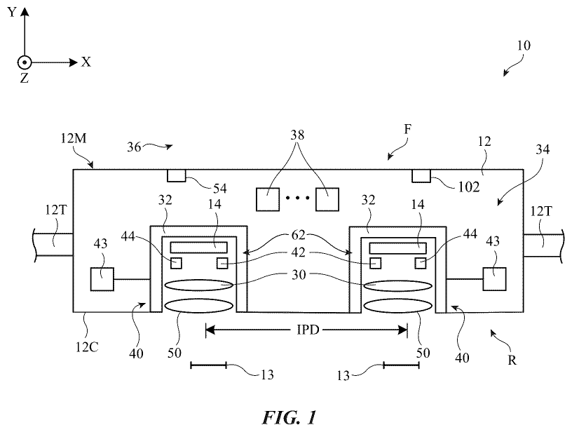

A top view of an illustrative head-mounted device or other eyewear is shown in FIG. 1. As shown in FIG. 1, head-mounted devices such as electronic device 10 may have head-mounted support structures such as housing 12. Housing 12 may include portions (e.g., support structures 12T) to allow device 10 to be worn on a user's head. Support structures 12T may be formed from fabric, polymer, metal, and/or other material. Support structures 12T may form a strap or other head-mounted support structures to help support device 10 on a user's head. A main support structure (e.g., main housing portion 12M) of housing 12 may support electronic components such as displays 14. Main housing portion 12M may include housing structures formed from metal, polymer, glass, ceramic, and/or other material. For example, housing portion 12M may have housing walls on front face F and housing walls on adjacent top, bottom, left, and right side faces that are formed from rigid polymer or other rigid support structures and these rigid walls may optionally be covered with electrical components, fabric, leather, or other soft materials, etc. The walls of housing portion 12M may enclose internal components 38 in interior region 34 of device 10 and may separate interior region 34 from the environment surrounding device 10 (exterior region 36). Internal components 38 may include integrated circuits, actuators, batteries, sensors, and/or other circuits and structures for device 10. Housing 12 may be configured to be worn on a head of a user and may form glasses, a hat, a helmet, goggles, and/or other head-mounted device. Configurations in which housing 12 forms goggles may sometimes be described herein as an example.

Front face F of housing 12 may face outwardly away from a user's head and face. Opposing rear face R of housing 12 may face the user. Portions of housing 12 (e.g., portions of main housing 12M) on rear face R may form a cover such as cover 12C (sometimes referred to as a curtain). The presence of cover 12C on rear face R may help hide internal housing structures, internal components 38, and other structures in interior region 34 from view by a user.

Device 10 may have left and right optical modules 40. Each optical module may include a respective display 14, lens 30, and support structure 32. Support structures 32, which may sometimes be referred to as lens barrels or optical module support structures, may include hollow cylindrical structures with open ends or other supporting structures to house displays 14 and lenses 30. Support structures 32 may, for example, include a left lens barrel that supports a left display 14 and left lens 30 and a right lens barrel that supports a right display 14 and right lens 30.

Displays 14 may include arrays of pixels or other display devices to produce images. Displays 14 may, for example, include organic light-emitting diode pixels formed on substrates with thin-film circuitry and/or formed on semiconductor substrates, pixels formed from crystalline semiconductor dies, liquid crystal display pixels, scanning display devices, and/or other display devices for producing images.

Lenses 30 may include one or more lens elements for providing image light from displays 14 to respective eyes boxes 13. Lenses 30 may be implemented using refractive glass lens elements, using mirror lens structures (catadioptric lenses), using Fresnel lenses, using holographic lenses, and/or other lens systems.

When a user's eyes are located in eye boxes 13, displays (display panels) 14 operate together to form a display for device 10 (e.g., the images provided by respective left and right optical modules 40 may be viewed by the user's eyes in eye boxes 13 so that a stereoscopic image is created for the user). The left image from the left optical module fuses with the right image from a right optical module while the display is viewed by the user.

If desired, device 10 may include additional lenses such as lenses 50. Lenses 50 may be fixed lenses or may be adjustable lenses such as liquid crystal lenses, fluid-filled lenses, or other suitable adjustable lenses. Lenses 50 may be configured to accommodate different focal ranges and/or to correct for vision defects such as myopia, hyperopia, presbyopia, astigmatism, higher-order aberrations, and/or other vision defects. For example, lenses 50 may be adjustable prescription lenses having a first set of optical characteristics for a first user with a first prescription and a second set of optical characteristics for a second user with a second prescription. Lenses 50 may be removably or permanently attached to housing 12. In arrangements where lenses 50 are removable, lenses 50 may have mating engagement features, magnets, clips, or other attachment structures that allow lenses 50 to be attached to housing 12 (e.g., individually or as a pair).

If desired, device 10 may be used purely for vision correction (e.g., device 10 may be a pair of spectacles, glasses, etc.) and some of the other components in FIG. 1 such as displays 14, lenses 30, and optical modules 40 may be omitted. In other arrangements, device 10 (sometimes referred to as eyewear 10, glasses 10, head-mounted device 10, etc.) may include displays that display virtual reality, mixed reality, and/or augmented reality content. With this type of arrangement, lenses 50 may be prescription lenses and/or may be used to move content between focal planes from the perspective of the user. If desired, lenses 50 may be omitted. Arrangements in which device 10 is a head-mounted device with one or more displays are sometimes described herein as an illustrative example.

It may be desirable to monitor the user's eyes while the user's eyes are located in eye boxes 13. For example, it may be desirable to use a camera to capture images of the user's irises (or other portions of the user's eyes) for user authentication. It may also be desirable to monitor the direction of the user's gaze. Gaze tracking information may be used as a form of user input and/or may be used to determine where, within an image, image content resolution should be locally enhanced in a foveated imaging system. To ensure that device 10 can capture satisfactory eye images while a user's eyes are located in eye boxes 13, each optical module 40 may be provided with gaze tracking circuitry 62. Gaze tracking circuitry 62 may include one or more cameras such as camera 42, and one or more light sources such as light source 44 (e.g., light-emitting diodes, lasers, lamps, etc.). Device 10 may include gaze tracking circuitry 62 for each eye (e.g., a left eye and a right eye), or device 10 may include gaze tracking circuitry 62 for a single eye.

Cameras 42 and light-emitting diodes 44 may operate at any suitable wavelengths (visible, infrared, and/or ultraviolet). With an illustrative configuration, which may sometimes be described herein as an example, diodes 44 emit infrared light that is invisible (or nearly invisible) to the user. This allows eye monitoring operations to be performed continuously without interfering with the user's ability to view images on displays 14.

Not all users have the same interpupillary distance IPD. To provide device 10 with the ability to adjust the interpupillary spacing between modules 40 along lateral dimension X and thereby adjust the spacing IPD between eye boxes 13 to accommodate different user interpupillary distances, device 10 may be provided with actuators 43. Actuators 43 can be manually controlled and/or computer-controlled actuators (e.g., computer-controlled motors) for moving support structures 32 relative to each other. Information on the locations of the user's eyes may be gathered using, for example, cameras 42. The locations of eye boxes 13 can then be adjusted accordingly.

Gaze information may also be used to determine a distance at which the user's gaze is fixated (sometimes referred to as fixation distance). Fixation distance may be used to adjust one or more components in device 10 such as adjustable lenses 50. For example, the focal power of lenses 50 may be adjusted based on fixation distance.

Device 10 may include sensors such as one or more depth sensors for measuring depth maps of the environment around device 10. For example, device 10 may include one or more depth sensors such as depth sensors 54. Depth sensors 54 may include may include light-based proximity sensors, time-of-flight camera sensors, camera-based depth sensors using parallax, a structured light depth sensor (e.g., having an emitter such as a dot projector that emits beams of light in a grid, a random dot array, or other pattern, and having an image sensor that generates depth maps based on the resulting spots of light produced on target objects), sensors that gather three-dimensional depth information using a pair of stereoscopic image sensors, lidar (light detection and ranging) sensors, radar sensors (e.g., based on ultra-wideband radio frequency signals), single cameras whose output is analyzed by machine learning, single cameras in conjunction with an inertial motion sensor, and/or any other suitable depth sensor. Pupil location information from gaze tracking circuitry 62 may be used to determine which external object the user is fixated on, and depth sensor information from depth sensors 54 may be used to determine the distance to that object. In some arrangements, the focal power of lenses 50 and/or the operation of display 14 may be adjusted based on the distance at which the user's gaze is fixated.

In addition to viewing real-world objects in the user's environment through device 10, a user may view virtual display content that is displayed by display 14. If desired, control circuitry in device 10 may be configured to determine the distance at which the virtual content is displayed relative to the user. Pupil location information from gaze tracking circuitry 62 may be used to determine which virtual object is aligned with the user's gaze, and the control circuitry in device 10 may determine the distance at which that virtual object is being displayed. In some arrangements, the focal power of lenses 50 and/or the operation of display 14 may be adjusted based on the distance to the virtual object at which the user's gaze is fixated.

If desired, device 10 may include an outward-facing camera such as outward-facing camera 102 (e.g., a visible light image sensor, an infrared image sensor, and/or any other suitable forward-facing image sensor) that can analyze the saliency of objects in the scene. Such saliency can be used by device 10 to modulate estimates of the user's gaze direction. If desired, device 10 can employ machine learning techniques or other statistical inference techniques to refine predictions of where the user will gaze.

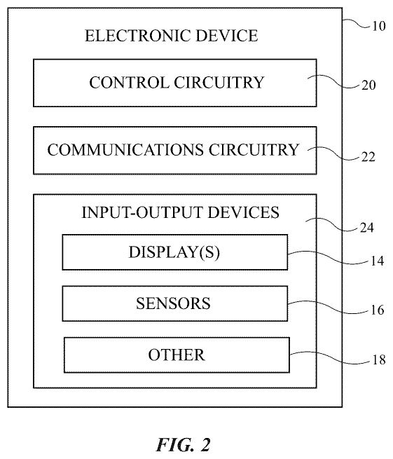

A schematic diagram of an illustrative electronic device such as a head-mounted device or other wearable device is shown in FIG. 2. Device 10 of FIG. 2 may be operated as a stand-alone device and/or the resources of device 10 may be used to communicate with external electronic equipment. As an example, communications circuitry in device 10 may be used to transmit user input information, sensor information, and/or other information to external electronic devices (e.g., wirelessly or via wired connections). Each of these external devices may include components of the type shown by device 10 of FIG. 2.

As shown in FIG. 2, a head-mounted device such as device 10 may include control circuitry 20. Control circuitry 20 may include storage and processing circuitry for supporting the operation of device 10. The storage and processing circuitry may include storage such as nonvolatile memory (e.g., flash memory or other electrically-programmable-read-only memory configured to form a solid state drive), volatile memory (e.g., static or dynamic random-access-memory), etc. Processing circuitry in control circuitry 20 may be used to gather input from sensors and other input devices and may be used to control output devices. The processing circuitry may be based on one or more microprocessors, microcontrollers, digital signal processors, baseband processors and other wireless communications circuits, power management units, audio chips, application specific integrated circuits, etc. During operation, control circuitry 20 may use display(s) 14 and other output devices in providing a user with visual output and other output.

To support communications between device 10 and external equipment, control circuitry 20 may communicate using communications circuitry 22. Circuitry 22 may include antennas, radio-frequency transceiver circuitry, and other wireless communications circuitry and/or wired communications circuitry. Circuitry 22, which may sometimes be referred to as control circuitry and/or control and communications circuitry, may support bidirectional wireless communications between device 10 and external equipment (e.g., a companion device such as a computer, cellular telephone, or other electronic device, an accessory such as a point device, computer stylus, or other input device, speakers or other output devices, etc.) over a wireless link. For example, circuitry 22 may include radio-frequency transceiver circuitry such as wireless local area network transceiver circuitry configured to support communications over a wireless local area network link, near-field communications transceiver circuitry configured to support communications over a near-field communications link, cellular telephone transceiver circuitry configured to support communications over a cellular telephone link, or transceiver circuitry configured to support communications over any other suitable wired or wireless communications link. Wireless communications may, for example, be supported over a Bluetooth® link, a WiFi® link, a wireless link operating at a frequency between 10 GHz and 400 GHz, a 60 GHz link, or other millimeter wave link, a cellular telephone link, or other wireless communications link. Device 10 may, if desired, include power circuits for transmitting and/or receiving wired and/or wireless power and may include batteries or other energy storage devices. For example, device 10 may include a coil and rectifier to receive wireless power that is provided to circuitry in device 10.

Device 10 may include input-output devices such as devices 24. Input-output devices 24 may be used in gathering user input, in gathering information on the environment surrounding the user, and/or in providing a user with output. Devices 24 may include one or more displays such as display(s) 14. Display(s) 14 may include one or more display devices such as organic light-emitting diode display panels (panels with organic light-emitting diode pixels formed on polymer substrates or silicon substrates that contain pixel control circuitry), liquid crystal display panels, microelectromechanical systems displays (e.g., two-dimensional mirror arrays or scanning mirror display devices), display panels having pixel arrays formed from crystalline semiconductor light-emitting diode dies (sometimes referred to as microLEDs), and/or other display devices.

Sensors 16 in input-output devices 24 may include force sensors (e.g., strain gauges, capacitive force sensors, resistive force sensors, etc.), audio sensors such as microphones, touch and/or proximity sensors such as capacitive sensors such as a touch sensor that forms a button, trackpad, or other input device), and other sensors. If desired, sensors 16 may include optical sensors such as optical sensors that emit and detect light, ultrasonic sensors, optical touch sensors, optical proximity sensors, and/or other touch sensors and/or proximity sensors, monochromatic and color ambient light sensors, image sensors, fingerprint sensors, iris scanning sensors, retinal scanning sensors, and other biometric sensors, temperature sensors, sensors for measuring three-dimensional non-contact gestures (“air gestures”), pressure sensors, sensors for detecting position, orientation, and/or motion (e.g., accelerometers, magnetic sensors such as compass sensors, gyroscopes, and/or inertial measurement units that contain some or all of these sensors), health sensors such as blood oxygen sensors, heart rate sensors, blood flow sensors, and/or other health sensors, radio-frequency sensors, depth sensors (e.g., structured light sensors and/or depth sensors based on stereo imaging devices that capture three-dimensional images), optical sensors such as self-mixing sensors and light detection and ranging (lidar) sensors that gather time-of-flight measurements, humidity sensors, moisture sensors, gaze tracking sensors, electromyography sensors to sense muscle activation, facial sensors, and/or other sensors. In some arrangements, device 10 may use sensors 16 and/or other input-output devices to gather user input. For example, buttons may be used to gather button press input, touch sensors overlapping displays can be used for gathering user touch screen input, touch pads may be used in gathering touch input, microphones may be used for gathering audio input, accelerometers may be used in monitoring when a finger contacts an input surface and may therefore be used to gather finger press input, etc.

If desired, electronic device 10 may include additional components (see, e.g., other devices 18 in input-output devices 24). The additional components may include haptic output devices, actuators for moving movable housing structures, audio output devices such as speakers, light-emitting diodes for status indicators, light sources such as light-emitting diodes that illuminate portions of a housing and/or display structure, other optical output devices, and/or other circuitry for gathering input and/or providing output. Device 10 may also include a battery or other energy storage device, connector ports for supporting wired communication with ancillary equipment and for receiving wired power, and other circuitry.

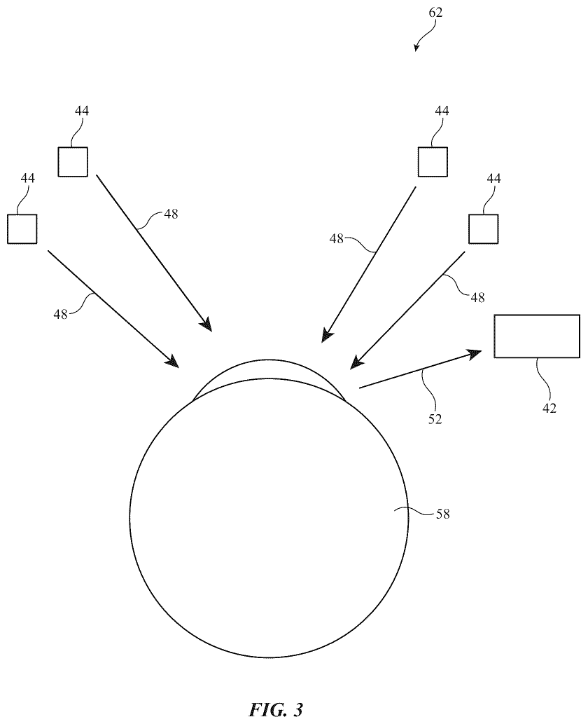

FIG. 3 is a top view of illustrative gaze tracking circuitry 62. Gaze tracking circuitry 62 may include one or more cameras such as camera 42 and one or more light sources such as light sources 44 (e.g., light-emitting diodes, lasers, lamps, etc.). Camera 42 and light-emitting diodes 44 may operate at any suitable wavelengths (visible, infrared, and/or ultraviolet). With an illustrative configuration, which may sometimes be described herein as an example, light-emitting diodes 44 emit infrared light that is invisible (or nearly invisible) to the user. This allows eye monitoring operations to be performed continuously without interfering with the user's ability to view images on displays 14.

During operation, one or more of light sources 44 may be used to emit light 48 towards eye 58. Light 48 may reflect off of eye 58 and reflected light 52 may be detected by camera 42. Emitted light 48 from light sources 44 may create one or more glints on eye 58. Camera 42 may capture images of eye 58 including the glints created by light 48. Based on the captured images, gaze tracking circuitry 62 may determine the location of the glints and the location of the user's pupil. Based on the locations of the glints produced on eye 58, gaze tracking circuitry 62 can determine the shape of the user's eye (e.g., the user's cornea), which in turn can be used to determine gaze direction.

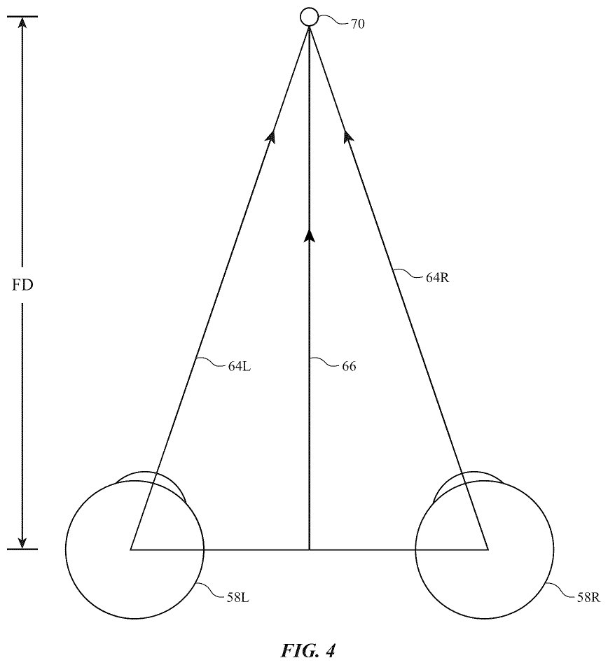

FIG. 4 is a diagram showing how the principals of vergence may be used to estimate a user's fixation distance based on the gaze direction measured by gaze tracking circuitry 62. As shown in FIG. 4, eyes 58L and 58R may be fixated on an object in the environment such as an object at location 70. Gaze tracking circuitry 62 may measure the gaze direction of left eye 58L and right eye 58R. Based on information from gaze tracking circuitry 62, a left eye gaze vector such as left eye gaze vector 64L (representing the gaze direction of a user's left eye) may be determined for left eye 58L, and a right eye gaze vector such as right eye gaze vector 64R (representing the gaze direction of a user's right eye) may be determined for right eye 58R. Gaze vectors 64L and 64R (or the projection of gaze vectors 64L and 64R into a horizontal plane) may intersect at location 70, where the user's gaze is fixated. Based on left and right gaze vectors 64L and 64R, vector 66 may be determined. Vector 66 may have a length that is equal to the fixation distance FD at which the user's eyes are fixated. This is sometimes referred to as a vergence-based fixation depth estimate.

If desired, device 10 may include a vergence change sensor that detects changes in vergence, which may be more reliable in some situations than an absolute vergence estimate. Control circuitry 20 may use the vergence change sensor to track changes in vergence (instead of or in addition to tracking absolute vergence) to determine fixation distance while accounting for inherent calibration errors in gaze tracking sensors.

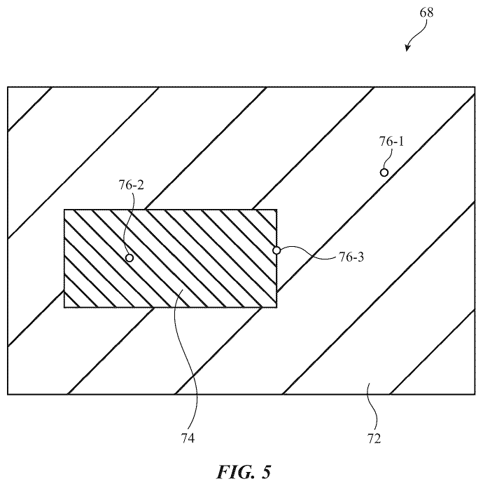

Care must be taken when relying upon vergence-based fixation depth estimates. Small errors in gaze angle may result in large errors in estimated fixation depth. To reduce errors in fixation depth, gaze information from gaze tracking circuitry 62 may be analyzed in conjunction with depth sensor data from depth sensor 54 (and, if desired, depth information associated with virtual display content on which the user is fixated) to determine fixation distance. This type of arrangement is illustrated in FIG. 5.

FIG. 5 is a diagram showing an illustrative depth map captured by depth sensor 54. Depth map 68 may include regions with different depth values, based on the measured distances to objects in the environment. For example, depth map 68 may include regions such as region 72 with a first measured depth value and region 74 with a second measured depth value that is different from the first measured depth value. Region 74 may include depth data gathered from objects in the environment that are closer to the user, whereas region 72 may include depth data gathered from objects in the environment that are farther away from the user (as an example).

Depth map 68 may be analyzed in conjunction with gaze information from gaze tracking circuitry 62 to more accurately determine a user's fixation distance. For example, a user may be wearing device 10 and viewing an environment through device 10 (e.g., through lenses 50). Depth sensor 54 may capture depth map 68 of the environment that the user is viewing through device 10. The user may gaze at various locations in the environment such as locations 76-1, 76-2 and 76-3. Gaze tracking circuitry 62 may be configured to measure gaze locations 76-1, 76-2 and 76-3, as discussed in connection with FIGS. 2 and 3. Control circuitry 20 may determine where gaze locations 76-1, 76-2 and 76-3 intersect with one or more depth maps 68 captured by depth sensor 54, which in turn can be used to determine fixation distance. For example, control circuitry 20 may determine that gaze position 76-1 intersects with region 72 of depth map 68. In this scenario, the fixation distance of the user may be equal to the depth value of region 72. When the user's gaze moves to position 76-2, control circuitry 20 may determine that gaze position 76-2 intersects with region 74 of depth map 68. In this scenario, the fixation distance of the user may be equal to the depth value of region 74.

If desired, depth map 68 may include depth information associated with virtual objects that are displayed by display 14. In this type of scenario, depth map 68 may be based on both measured depth values to real-world objects as well as computed depth values to virtual objects that are overlaid onto the environment by display 14.

Gaze information and depth data may not always provide unambiguous fixation depth estimates. When a user is fixated on or near a small object, a sharp edge, or a transparent object, it can be challenging to disambiguate on which depth the user is fixated. For example, gaze position 76-3 may be located at or near the edge of an object in region 74, making it difficult to determine whether the user is fixated on the object in region 74 or whether the user is fixated on an object further away (an object in region 72). If the user's fixation depth is estimated to be equal to the depth value of region 74, when the user is actually fixated on an object further away in region 72, the fixation depth estimation would be inaccurate.

One technique for avoiding inaccurate fixation depth estimates or increasing the depth estimate precision when there is noise in signals from gaze trackers or depth sensors is to impose a threshold requirement (e.g., hysteresis) for updating a previously gathered fixation depth estimate. A change in focal distance is often if not always accompanied by eye movement (sometimes referred to as a saccade). The absence of eye motion (e.g., the absence of a change in vergence) may therefore indicate that the user's fixation depth is unchanged. On the other hand, when the user's fixation depth does change, a rapid change in vergence should also be detected by gaze tracking circuitry 62. If desired, control circuitry 20 may hold off on providing the circuitry of device 10 with an updated fixation distance unless and until a threshold change in vergence is detected within a given threshold time window (e.g., a quarter of a second or other suitable time span). Once a threshold change in vergence is detected within the given threshold time window, it may be assumed that the user's focal distance has changed and that an updated fixation distance should be determined (e.g., using gaze tracking circuitry 62 and/or depth sensor 54, as discussed in connection with FIGS. 3, 4, and 5).

If desired, device 10 may use an inertial motion sensor to detect changes in head pose. Such changes may also serve as alternative evidence that the fixation depth may have changed. If desired, control circuitry 20 may provide the circuitry of device 10 with an updated fixation distance if a threshold change in head pose is detected within a given threshold time window (e.g., a quarter of a second or other suitable time span).

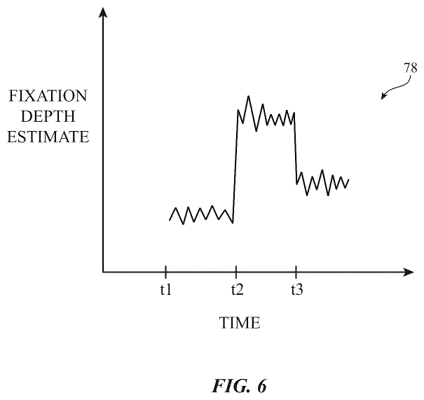

FIG. 6 is a graph showing how fixation depth estimates (e.g., vergence-based fixation depth estimates as discussed in connection with FIG. 4) may change over time during operation of device 10. Control circuitry 20 may use gaze tracking circuitry 62 to track a user's gaze direction from time t1 to time t3. Curve 78 illustrates how the vergence-based fixation depth estimate from gaze tracking circuitry 62 may change over time. From time t1 to time t2, gaze tracking circuitry 62 may measure some fluctuations in gaze direction and the corresponding fixation depth estimate associated with each gaze direction. If the changes in the fixation depth estimate are below a predetermined threshold amount of change (and/or if the changes in fixation depth do not occur within a predetermined time period), control circuitry 20 may assume that the user's focal distance is unchanged and may not provide any updated (e.g., recalculated) fixation depth value to the circuitry of device 10 (e.g., the power of adjustable lens 50 may remain unchanged from time t1 to time t2).

At time t2, gaze tracking circuitry 62 may measure a change in the fixation depth estimate and/or a change in the vertical and/or horizontal gaze direction that is greater than or equal to the predetermined threshold amount of change (and that occurs within the predetermined time period). This in turn triggers control circuitry 20 to calculate the updated fixation depth and provide the updated fixation depth to the circuitry of device 10 such as display 14 and/or lenses 50. For example, the power of adjustable lens 50 may be adjusted at time t2 in response to the detected change in estimated fixation distance. By unlocking hysteresis only when gaze tracking circuitry 62 detects a change in gaze position that exceeds a predetermined threshold, control circuitry 20 can reduce the chances of providing inaccurate fixation depth values to the circuitry of device 10.

If desired, control circuitry 20 may also hold off on cross-checking the vergence-based fixation depth estimate from gaze tracking circuitry 62 with depth data from depth sensor 54 (e.g., depth map 68) until the measured change in the fixation depth estimate exceeds the threshold amount. For example, control circuitry 20 may use gaze data alone to estimate fixation depth from time t1 to time t2 until the threshold amount of change is detected at time t2. In response to the threshold amount of change in estimated fixation distance being detected at time t2, depth sensor 54 may measure an updated depth map of the environment and control circuitry 20 may cross-check the vergence-based fixation depth estimate with the updated depth data (e.g., map 68) to determine an updated fixation depth value that should be provided to circuitry in device 10.

From time t2 to time t3, gaze tracking circuitry 62 may measure some fluctuations in gaze direction and the corresponding fixation depth estimate associated with each gaze direction. If the changes in the fixation depth estimate are less than a predetermined threshold amount of change (and/or if the changes in fixation depth do not occur within a predetermined time period), control circuitry 20 may assume that the user's focal distance is unchanged and may not provide any updated fixation depth value to the circuitry of device 10 (e.g., the power of adjustable lens 50 may remain unchanged from time t2 to time t3).

At time t3, gaze tracking circuitry 62 may measure a change in the fixation depth estimate that is greater than or equal to the predetermined threshold amount of change (and that occurs within the predetermined time period). This in turn triggers control circuitry 20 to calculate an updated fixation depth and provide the updated fixation depth to the circuitry of device 10 such as display 14 and/or lenses 50. For example, the power of adjustable lens 50 may be adjusted at time t3 in response to the detected change in estimated fixation distance.

If desired, control circuitry 20 may use gaze data alone to estimate fixation depth from time t2 to time t3 until the threshold amount of change is detected at time t3. At time t3, control circuitry 20 may cross-check the vergence-based fixation depth estimate with depth data (e.g., map 68) from depth sensor 54 to determine an updated fixation depth value that should be provided to circuitry in device 10. Depth sensing at specific times such as time t2 and time t3 may help conserve power.

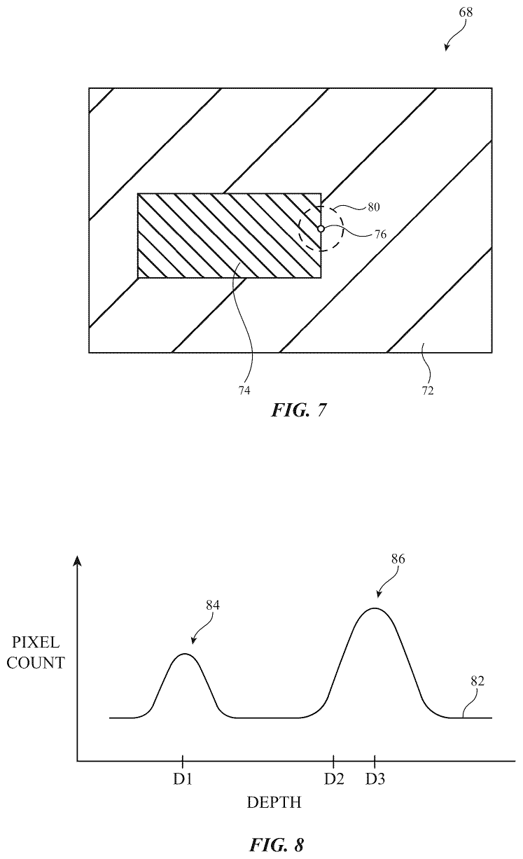

FIGS. 7 and 8 illustrate another technique for ensuring that accurate fixation depth measurements are provided to the circuitry of device 10 such as display 14 and/or lenses 50. These techniques may be applied as an addition or an alternative to the hysteresis technique of FIG. 6. FIG. 7 is a diagram of depth map 68 measured by depth sensor 54. As in the example of FIG. 5, depth map 68 may include regions with different depth values representing the distances to objects in the environment (e.g., an environment that is being viewed through lenses 50). For example, depth map 68 may include regions such as region 72 with a first measured depth value and region 74 with a second measured depth value that is different from the first measured depth value. Region 74 may include depth data gathered from objects in the environment that are closer to the user, whereas region 72 may include depth data gathered from objects in the environment that are farther away from the user (as an example). If desired, depth map 68 may also include distances to virtual objects that are displayed by display 14 and overlaid onto the environment. Control circuitry 20 may use display data and/or other information to determine depth values to virtual objects in the environment. Region 74, for example, may include depth data associated with virtual display content that is overlaid onto the environment by display 14.

Consider a scenario in which a user's gaze is positioned at gaze location 76. Gaze location 76, which is measured by gaze tracking circuitry 62, may be located near an edge between region 74 (at a first depth) and region 72 (at a second depth). To help disambiguate which distance the user is actually fixated on, control circuitry 20 may generate a histogram of the depth data that is measured at and around gaze location 76. For example, control circuitry 20 may generate a histogram of depth data within region 80 surrounding gaze location 76. The size of region 80 may, for example, be based on the expected error or tolerance of gaze tracking circuitry 62, if desired.

FIG. 8 is a graph such as a histogram of illustrative depth data such as depth data within region 80 of depth map 68 of FIG. 7. Curve 82 indicates how many pixels (e.g., depth sensing pixels in a depth sensing camera such as depth sensor 54) within region 80 measured a particular depth value. As shown in FIG. 8, curve 82 has first and second peaks such as first peak 84 and second peak 86. Peak 84 may represent the aggregate number of depth sensing pixels (e.g., pixels in region 74 of FIG. 7) that measure depth D1. Peak 86 may represent the aggregate number of depth sensing pixels (e.g., pixels in region 72 of FIG. 7) that measure depth D3. Depth D1 may be less than depth D3.

Control circuitry 20 may analyze the aggregate depth data such as curve 82 in conjunction with a vergence-based fixation depth measurement from gaze tracking circuitry 62. For example, based on the gaze direction of the user (and without yet taking into account depth sensor data), gaze tracking circuitry 62 may estimate that the user's fixation depth is equal to depth D2 (e.g., using the techniques discussed in connection with FIGS. 3 and 4). Depth D2 may be closer to peak 86 at depth D3 than peak 84 at depth D1, thus suggesting that the user is actually fixated on an object in region 72 at distance D3. If the vergence-based fixation depth measurement were instead closer to peak 84, then control circuitry 20 would determine that the user's actual fixation depth is equal to D1. In this way, control circuitry 20 may use the vergence-based fixation depth estimate to disambiguate depth data (e.g., to rule out one or more incorrect potential depths). Additionally, analyzing the local depth values around the gaze position (as opposed to the entire field of view of depth sensor 54) may help reduce the processing power needed to determine which peak is closest to the vergence-based fixation depth estimate. This is merely illustrative, however. If desired, the entirety of depth map 68 may be analyzed to determine which depth is closest to the vergence-based fixation depth estimate.

In some situations, gaze tracking circuitry 62 may deliver accurate estimates of vergence change without delivering accurate absolute vergence. In such situations, if desired, the change in vergence can be used to estimate when and how the actual fixation moves between peaks in the depth histogram such as peak 84 and peak 86.

If the scene includes objects that move in time, it may be that peaks in the depth histogram such as peaks 84 and 86 do not remain at constant values but instead change smoothly with time. This can happen for instance if the user or the object of fixation in the world is moving. In such a case, it may be advantageous to continuously update the depth estimate to track the moving peak corresponding to the current depth estimate so long as the vergence (e.g., the vergence-based fixation depth estimate) has not changed by a supra-threshold amount (such as the change at time t2 in FIG. 6).

If desired, vertical gaze angle information from gaze tracker 62 (e.g., absolute vertical gaze direction and/or changes in vertical gaze direction) can also be used to disambiguate the depth at which a user is fixated. For example, a downward shift in gaze angle may indicate that the user is fixated on a near object (e.g., at peak 84), whereas an upward shift in gaze angle may indicate that the user is fixated on a far object (e.g., at peak 86).

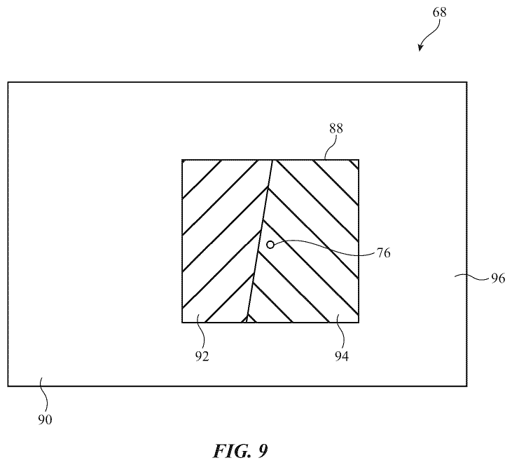

If desired, depth sensor 54 may be used to measure depth values only around the measured gaze position. This type of arrangement is illustrated in FIG. 9. As in the example of FIG. 5, depth map 68 of FIG. 9 may include measured depth values representing the distances to objects in the environment (e.g., an environment that is being viewed through lenses 50). For example, depth map 68 may include regions such as region 92 with a first measured depth value and region 94 with a second measured depth value that is different from the first measured depth value. Region 92 may include depth data gathered from objects in the environment that are closer to the user, whereas region 94 may include depth data gathered from objects in the environment that are farther away from the user (as an example).

In some arrangements, it may be desirable to interrogate depth sensor 54 only around the region of gaze position 76. For example, if depth map 68 represents the field of view of the entirety of depth sensor 54, control circuitry 20 may determine fixation distance using only a subregion of depth map 68 such as subregion 88 surrounding measured gaze position 76. Subregion 88 may have a size that is based on the known error or predicted error in gaze position 76 measured by gaze tracking circuitry 62. If desired, depth sensor 54 may measure depth data for the entirety of map 68 (e.g., the entire field of view of depth sensor 54) and control circuitry 20 may only analyze depth data from within region 88 to determine fixation distance (e.g., ignoring depth data in region 96).

In some arrangements, depth sensor 54 may be controlled to only gather depth data for region 88, without gathering depth data for region 96. In arrangements where depth sensor 54 is a pixelated depth sensor (e.g., having a two-dimensional array of emitters and/or a camera with a two-dimensional array of depth sensing pixels), certain pixels in depth sensor 54 such as depth sensing pixels in region 96 can be inactive during depth sensing measurements while other pixels such as depth sensing pixels in region 88 are active during depth sensing measurements. For example, some emitters in depth sensor 54 may actively illuminate region 88 while region 96 may not be illuminated by emitters in depth sensor 54. Detector pixels in region 88 may be active while detector pixels in region 96 may be inactive.

If desired, depth sensor 54 may include one or more beam steering devices such as a microelectromechanical systems (MEMS) galvo mirror or spatial light modulator to steer depth sensing infrared light to region 88 based on gaze position 76 from gaze tracking circuitry 62. If desired, depth sensor 54 may include an addressable laser array (e.g., an array of vertical cavity surface emitting lasers) and an array of single photon avalanche photodiodes, and control circuitry 20 may determine which laser to turn on based on the measured gaze direction (e.g., position 76 measured by gaze tracking circuitry 62). The coupled beam steering device may be configured to raster scan a pulsed laser beam within the instantaneous field of view (e.g., as determined by the pitch of the laser array).

Depth sensor data that is gathered for active region 88 may be analyzed in conjunction with gaze position information (e.g., as discussed in connection with FIGS. 1-8) to determine the fixation distance of the user.

As described above, one aspect of the present technology is the gathering and use of information such as information from input-output devices. The present disclosure contemplates that in some instances, data may be gathered that includes personal information data that uniquely identifies or can be used to contact or locate a specific person. Such personal information data can include demographic data, location-based data, telephone numbers, email addresses, social media information, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-generated reality: in contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands). A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects. Examples of CGR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground. Examples of mixed realities include augmented reality and augmented virtuality. Augmented reality: an augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: an augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Hardware: there are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, μLEDs, liquid crystal on silicon, laser scanning light sources, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The foregoing is merely illustrative and various modifications can be made to the described embodiments. The foregoing embodiments may be implemented individually or in any combination.

What is claimed is:

1. A head-mounted device, comprising:
a lens through which an environment is viewable;
gaze tracking circuitry configured to measure gaze position, wherein a fixation distance is determined based on the measured gaze position; and
a depth sensor configured to measure a depth map of the environment in response to a change in the fixation distance that exceeds a predetermined threshold.

2. The head-mounted device defined in claim 1 wherein the fixation distance is recalculated based on the measured gaze position and the depth map in response to the change in the fixation distance that exceeds the predetermined threshold.

3. The head-mounted device defined in claim 2 wherein the lens comprises an adjustable lens and wherein a power of the adjustable lens is adjusted based on the recalculated fixation distance.

4. The head-mounted device defined in claim 1 wherein the depth sensor is configured to measure the depth map of the environment in response to the change in the fixation distance occurring within a predetermined time span.

5. The head-mounted device defined in claim 1 wherein the depth map comprises different depth values associated with different respective regions in the environment, wherein the measured gaze position intersects with a location on the depth map, and wherein the fixation distance is determined based on the depth values at the location on the depth map.

6. The head-mounted device defined in claim 5 wherein the fixation distance is determined based on a histogram of the depth values within a subregion of the depth map, wherein the histogram comprises a first peak at a first depth value and a second peak at a second depth value, and wherein the fixation distance is determined to be equal to the first depth value or the second depth value based on the measured gaze position.

7. The head-mounted device defined in claim 6 wherein the fixation distance is determined to track the first peak or the second peak until the gaze tracking circuitry detects a change in vergence that exceeds an additional predetermined threshold.

8. The head-mounted device defined in claim 1 wherein the depth map includes first depth values and second depth values, wherein the first depth values are measured by the depth sensor and are associated with real-world objects in the environment, and wherein the second depth values are associated with virtual content that is overlaid onto the environment.

9. The head-mounted device defined in claim 1 further comprising a display configured to display images that are viewable through the lens from an eye box, wherein the display is adjusted based on the fixation distance.

10. The head-mounted device defined in claim 1 wherein the fixation depth is determined based at least partly on additional sensor data from a sensor selected from the group consisting of: a motion sensor and a forward-facing camera.

11. Eyewear, comprising:
a lens through which an environment is viewable;
gaze tracking circuitry configured to measure gaze position; and
a depth sensor configured to measure a depth map of the environment, wherein the depth map includes depth values within a subregion of the environment surrounding the gaze position and wherein a fixation distance is determined based on the gaze position and the depth values.

12. The eyewear defined in claim 11 wherein the fixation distance is determined based on a histogram of the depth values within the subregion.

13. The eyewear defined in claim 11 wherein the depth sensor is configured to measure an updated depth map of the environment in response to a change in the measured gaze position that exceeds a predetermined threshold.

14. The eyewear defined in claim 11 wherein the lens comprises a liquid crystal lens and wherein a power of the liquid crystal lens is adjusted based on the fixation distance.

15. The eyewear defined in claim 11 further comprising a display configured to display images that are viewable through the lens from an eye box, wherein the display is adjusted based on the fixation distance.

16. Eyewear, comprising:
a lens through which an environment is viewable;
gaze tracking circuitry configured to measure gaze position; and
a depth sensor configured to measure a depth map of a portion of the environment based on the measured gaze position, wherein a fixation distance is determined based on the measured gaze position and the depth map.

17. The eyewear defined in claim 16 wherein the depth sensor is configured to steer illumination towards the portion of the environment based on the measured gaze position.

18. The eyewear defined in claim 16 wherein at least some pixels in the depth sensor are inactive while other pixels in the depth sensor measure the depth map.

19. The eyewear defined in claim 16 wherein a focal power of the lens is adjusted based on the fixation depth.

20. The eyewear defined in claim 16 wherein the depth sensor is configured to measure an updated depth map in response to a change in the measured gaze position that exceeds a predetermined threshold.
